(19) United States
(12) Patent Application Publication
(10) Pub. No.: US 2021/0098842 A1
(43) Pub. Date: Apr. 1, 2021

(54) BATTERY SYSTEM

(71) Applicant: Mahle International GmbH, Stuttgart (DE)

(72) Inventors: Peter Nowak, Stuttgart (DE); Oleksandr Pavlov, Herrenberg (DE); Daniel Rothmaier, Maulbronn (DE)

(21) Appl. No.: 17/031,892

(22) Filed: Sep. 24, 2020

(30) Foreign Application Priority Data
Sep. 26, 2019 (DE) 10 2019 214 755.0

(51) Int. Cl. H01M 10/6568; H01M 10/613; H01M 2/10; H01M 10/6556; H01M 10/625

(52) U.S. Cl. CPC H01M 10/6568; H01M 10/613; H01M 2/1094; H01M 2220/20; H01M 2/1077; H01M 10/625; H01M 10/6556

(57) ABSTRACT

A battery system may include a battery housing, a pressure-equalizing device, and a circuit. At least one rechargeable battery cell may be accommodated in the battery housing. A gas may be flowable through the pressure-equalizing device to equalize a pressure between the battery housing and a surroundings disposed outside the battery housing. A cooling liquid may circulate through the circuit during operation. The battery housing may be integrated in the circuit such that the cooling liquid flows around the at least one battery cell during operation. The pressure-equalizing device may be configured such that the pressure-equalizing device is impermeable to the cooling liquid flowing from the circuit in a direction of the surroundings.

### CROSS-REFERENCE TO RELATED APPLICATIONS

This application claims priority to German Patent Application No. DE 10 2019 214 755.0, filed on Sep. 26, 2019, the contents of which is hereby incorporated by reference in its entirety.

### TECHNICAL FIELD

The present invention relates to a battery system having a battery housing in which at least one rechargeable battery cell is accommodated, and having a circuit for cooling the at least one battery cell.

### BACKGROUND

The use of rechargeable batteries is sufficiently known. In this context, in particular in motor vehicles there is increasing use of such batteries. The requirement made of the efficiency of such batteries and/or of the fastest possible recharging of the batteries results in a situation in which during operation such batteries generate heat which has to be carried away. This is usually done by cooling the battery cells. The battery cells are usually accommodated in a battery housing, wherein the battery housing is connected in a heat-transmitting fashion to a heat sink and/or a heat exchanger, in order to cool the battery cells arranged within the battery housing.

While the battery is operating, thermal fluctuations and/or changes in the weather can give rise to pressure differences within the battery housing which can adversely affect the functioning of the battery and/or can damage the battery.

DE 10 2013 004 754 A1 discloses such a battery which is a component of a battery system. A gas is cooled in the battery system and conducted through the battery housing in order to cool the battery cells. In order to permit pressure equalization between the battery housing and the surroundings and to reduce the moisture content within the battery housing, a sealing arrangement is provided which permits a flow of gas between the battery housing and the surroundings in order to equalize pressure within the battery housing. The sealing arrangement penetrates the battery housing and has, within the battery housing, a desiccant which absorbs moisture from the gas flowing through the sealing arrangement.

### SUMMARY

The present invention is concerned with the problem of specifying, for a battery system of the type mentioned at the beginning, an improved or at least different embodiment which is distinguished, in particular, by increased efficiency and/or operational reliability.

This problem is solved according to the invention by means of the subject matter of the independent claim(s). Advantageous embodiments are the subject matter of the dependent claim(s).

The present invention is based on the general concept of directly cooling rechargeable battery cells in a battery system with a cooling liquid and of providing the system with a pressure-equalizing device which permits pressure equalization with the surroundings and prevents the cooling liquid from flowing out into the surroundings. In this way, the cooling of the battery cells is carried out more effectively and to a greater extent, so that the battery cells can be operated with increased power and/or can be recharged. The pressure equalization brings about increased operational reliability of the battery system, which reliability is increased by virtue of the fact that the cooling liquid is prevented from flowing out via the pressure-equalizing device, or such a flow is at least reduced.

According to the inventive concept the battery system has a battery housing in which at least one rechargeable battery cell is accommodated. The battery system also has a circuit in which a cooling liquid circulates during operation. The battery housing is integrated into the circuit in such a way that the cooling liquid flows around at least one of the at least one battery cells during operation. This so-called direct cooling or immersion cooling provides effective and efficient cooling of the at least one battery cell. The battery system also has a pressure-equalizing device which connects the circuit to the surroundings in such a way that gas flows between the circuit and the surroundings via the pressure-equalizing device in order to compensate pressure in the pressure housing. The pressure-equalizing device is configured according to the invention in such a way that it prevents the flow of liquid from the circuit into the surroundings. The pressure-equalizing device is therefore impermeable to liquid flowing from the circuit in the direction of the surroundings.

The battery housing expediently has an internal volume in which the at least one battery cell is arranged and through which cooling liquid flows during operation. In this context, gas flows between the internal volume and the surroundings in order to equalize pressure.

The surroundings are formed here, in particular, by space surrounding the circuit, in particular the battery housing. In particular, the surroundings are formed by a space outside the internal volume of the battery housing. Therefore, in order to equalize pressure an exchange of gas with the space occurs via the pressure-equalizing device.

The pressure-equalizing device is expediently arranged outside the circuit. That is to say the pressure-equalizing device is arranged in such a way that during operation the cooling liquid does not flow through it and/or the cooling liquid does not flow around it. This prevents, in particular, the pressure-equalizing device from being flooded by the cooling liquid during operation, and the flow of the gas for pressure equalization is not possible or the corresponding risk is at least reduced.

The pressure-equalizing device can in principle be arranged at any desired location in the circuit.

In preferred embodiments, the pressure-equalizing device is mounted on the battery housing. It is therefore possible to carry out pressure equalization directly on the battery housing. In particular, this prevents gas located in the battery housing from flowing out of the battery housing and into the circuit or at least reduces the corresponding risk.

The pressure-equalizing device is advantageously mounted on the battery housing on the outside thereof, and is expediently connected fluidically to the internal volume of the battery housing. The pressure-equalizing device is advantageously arranged in an operating position of the battery system, on the top of the battery housing with respect to the direction of gravity. Such an arrangement of the pressure-equalizing device makes use of the knowledge that gas which is located in the battery housing rises upwards, so that the arrangement of the pressure-equalizing device on the top of the housing brings about a situation in which the pressure-equalizing device for the pressure equalization is predominantly in contact with the gas. Consequently, the coolant does not come into contact with the pressure-equalizing device, or only does to a small extent. In this way, the impermeability of the pressure-equalizing device to liquid can be implemented in a simplified fashion. The pressure equalization is therefore possible efficiently and simply.

In preferred embodiments, the pressure-equalizing device has a drying device. The drying device extracts moisture from gas flowing through the pressure-equalizing device. Therefore, during the pressure equalization no moisture, or at least a reduced quantity of moisture, can enter the circuit, in particular the battery housing. In particular, this prevents that the cooling liquid is contaminated with moisture from the surroundings, or such contamination is at least reduced. The contamination of the cooling liquid can lead to a reduced cooling capacity of the cooling liquid, which can lead to a reduction in the performance of the battery system. The contamination can also bring about changes in the electrical properties of the cooling liquid, which can cause damage to the battery system. In addition, when water enters the cooling liquid through electrolysis of water, oxyhydrogen can be produced, and the electrical conductivity of current-conducting components can be reduced, wherein these processes are prevented or at least reduced by the drying device. The drying device also brings about increased operational reliability and/or an improved capacity of the battery system.

The drying device can in principle be configured in any desired fashion. In particular, the drying device has a desiccant and/or absorbent for absorbing moisture from the gas. The desiccant can be, in particular, a silica gel, zeolite and the like or mixtures thereof.

Embodiments in which the pressure-equalizing device is impermeable overall to liquid are particularly preferred. This means that the pressure-equalizing device is impermeable not only to the flow of liquid into the surroundings but also to the flow of liquid from the surroundings into the circuit, in particular into the battery housing. Therefore, corresponding penetration of liquid, in particular of water, from the surroundings into the circuit, in particular into the battery housing, is prevented or at least reduced. This brings about increased operational reliability of the battery system and at the same time an increased service life of the pressure-equalizing device.

Embodiments in which the pressure-equalizing device has a diaphragm which is permeable to gas and impermeable to liquid are to be considered advantageous. That is to say the impermeability of the pressure-equalizing device to liquid is implemented at least partially by means of the diaphragm. The diaphragm, also referred to below as first diaphragm is preferably also impermeable to particles, so that said diaphragm also prevents or at least reduces the penetration of dust and dirt into the circuit, in particular into the battery housing.

Embodiments in which the drying device is arranged between the surroundings and the first diaphragm are preferred. The first diaphragm therefore serves, in particular, the purpose of preventing or at least reducing the flow of cooling liquid from the pressure-equalizing device and in the direction of the drying device. The first diaphragm also prevents liquid, which can be formed in the drying device through collected or bound moisture, from flowing from the drying device into the circuit, in particular into the battery housing, or at least reduces the corresponding risk.

Embodiments in which the pressure-equalizing device has a further diaphragm which is permeable to gas and impermeable to liquid are advantageous, wherein this further diaphragm is also referred to in the following text as the second diaphragm. The second diaphragm is arranged between the drying device and the surroundings. The second diaphragm therefore prevents, in particular, liquid, in particular water, from passing from the surroundings to the drying device and therefore adversely effecting the functioning of the drying device and/or damaging the drying device, or at least reduces the corresponding risk. The second diaphragm is advantageously also impermeable to particles, so that dust and dirt do not pass to the drying device and/or to the first diaphragm and therefore into the circuit, in particular into the battery housing, or at least do so to a reduced extent.

The drying device can in principle be exchangeable so that when necessary, for example when the desiccant is saturated, it can be exchanged. For this purpose, the drying device can be embodied in the manner of a cartridge.

Embodiments in which the drying device can be regenerated, so that bound and/or collected moisture in the drying device is discharged when necessary are preferred.

For the purpose of regeneration, the pressure-equalizing device advantageously has a heating device which heats the drying device for the purpose of regeneration. In this way, the battery system, in particular the pressure-equalizing device, can be operated without maintenance or at least with reduced maintenance.

In this context, embodiments in which a closure device which can be a component of the equalizing device is provided are advantageous. The closure device is arranged between the drying device and the circuit, in particular the battery housing, and in a regeneration position it shuts a fluidic connection between the drying device and the circuit, in particular the battery housing. During regeneration of the drying device, the closure device is expediently adjusted here into the regeneration position in order to prevent liquid which flows out of the drying device from entering the circuit during the regeneration. In particular, in the regeneration position the closure device prevents liquid which is produced during the regeneration from passing to the first diaphragm, or at least reduces the passing of said liquid. As result, corresponding adverse effects and/or damage to the first diaphragm are/is prevented or at least reduced. The closure device is expediently adjustable here between the regeneration position and an operating position, wherein in the operating position said closure device opens the fluidic connection between the circuit and the drying device.

In preferred embodiments, the pressure-equalizing device has a protective cover which is mounted on the outside of the pressure-equalizing device. The protective cover is provided with at least one flow opening which permits a fluidic flow between the pressure-equalizing device and the surroundings. The protective cover provides, in particular, protection of the pressure-equalizing device, in particular of the first diaphragm and/or of the second diaphragm and/or of the drying device and/or of the heating device, with respect to mechanical effects, so that corresponding damage is prevented or at least reduced. In addition, the protective cover prevents particles, in particular dust and dirt, from entering the pressure-equalizing device or allows it to do so only to a reduced extent.

It is preferred here if at least one of the at least one flow openings runs at an incline with respect to the direction of gravity. This causes the flow of gas through the flow opening to occur in a simplified fashion. However, liquid and/or particles and/or dirt from the surroundings cannot enter the pressure-equalizing device, or at least can only do so with difficulty.

The battery system can be basically used in any desired application.

The battery system is used, in particular, in a motor vehicle in which the battery serves as an energy store and is used, for example, to drive the motor vehicle.

Further important features and advantages of the invention can be found in the dependent claims, the drawings and the associated description of the figures with reference to the drawings.

It goes without saying that the features which are mentioned above and those which are still to be explained below can be used not only in the respectively specified combination but also in other combinations or alone without departing from the scope of the present invention.

Preferred exemplary embodiments of the invention are illustrated in the drawings and explained in more detail in the following description, wherein identical reference symbols refer to identical or similar or functionally identical components.

### BRIEF DESCRIPTION OF THE DRAWINGS

In the drawings, in each case in a schematic form:

FIG. 1 shows a highly simplified, circuit-diagram-like representation of a battery system with a pressure-equalizing device,

FIG. 2 shows a highly simplified, circuit-diagram-like representation of the battery system in another exemplary embodiment,

FIG. 3 shows an enlarged view of the pressure-equalizing device from FIGS. 1 and 2, and

FIG. 4 shows the view from FIG. 3 in a further exemplary embodiment of the pressure-equalizing device.

### DETAILED DESCRIPTION

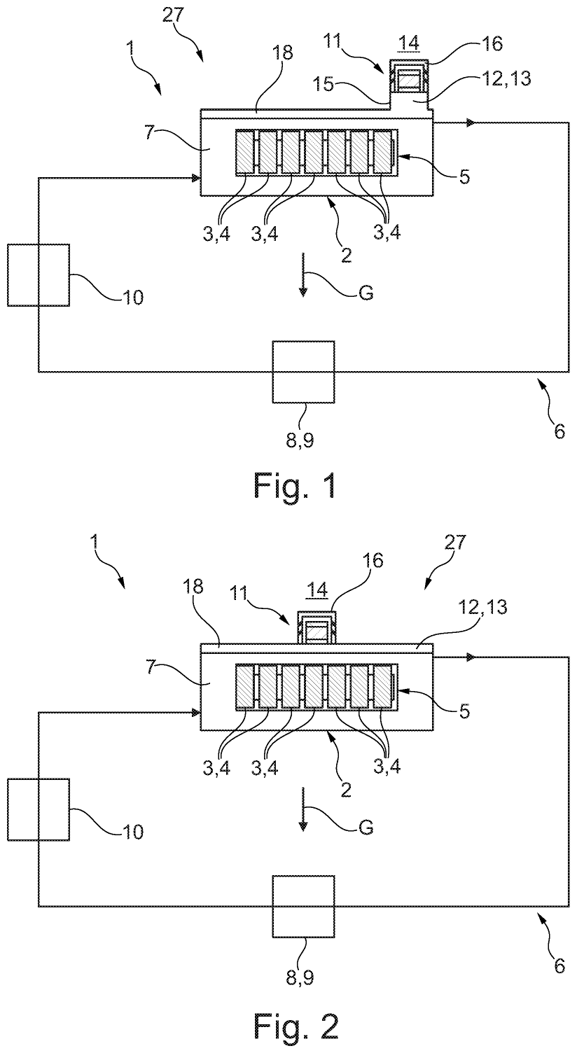

A battery system 1 as shown in FIGS. 1 and 2 has a battery housing 2. The battery housing 2 has an internal volume 18 in which at least one rechargeable battery cell 3, for example a pouch cell 4 is received. In the examples shown, seven such battery cells 3 are provided in the battery housing 2 purely by way of example. The battery cells 3 are combined here to form a cell module 5 in which they are, in particular, placed electrically in contact with one another. The battery system 1 also has a circuit 6 through which a cooling liquid 7 circulates during operation. For this purpose, a feed device 8, for example a pump 9, for feeding the cooling liquid 7 can be provided in the circuit 6. The battery housing 2 is also integrated into the circuit 6 in such a way that the cooling liquid 7 flows through the internal volume 18 of the battery housing 2 and in the process flows around at least one of the battery cells 3, the cell module 5 in the example shown. The cell module 5 is therefore located in the cooling liquid 7 during operation in the example shown and is cooled directly by the cooling liquid 7. The at least one battery cell 3, in particular the cell module 5, therefore experiences what is referred to as direct cooling or immersion cooling here. In the examples shown, a cooling liquid radiator 10, which is also integrated into the circuit 6, is provided for cooling the cooling liquid 7.

The battery system 1 also has a pressure-equalizing device 11 with which the pressure inside the battery housing 2 is equalized. For this purpose, gas 12, in particular air 13, which is present in the internal volume 18 of the battery housing 2 is exchanged via the pressure-equalizing device 11 with the surroundings 14 of the circuit 6, in particular of the battery housing 2. In order to equalize pressure in the battery housing 2, gas 12, in particular air 13, therefore flows from the battery housing 2 via the pressure-equalizing device 11 into the surroundings 14 and/or from the surroundings 14 into the battery housing 2. In the exemplary embodiments shown, the pressure-equalizing device 11 is mounted on the outside of the battery housing 2. In this context, in the operating position of the battery system 1, the pressure-equalizing device 11 is mounted on the top of the housing with respect to a direction G of gravity, so that the pressure-equalizing device 11 is adjacent to the gas 12 which is located in the battery housing 2.

In the exemplary embodiment shown in FIG. 1, the pressure-equalizing device 11 is separate from the battery housing 2 and is connected to a connecting piece 15 of the battery housing 2. In the exemplary embodiment shown in FIG. 2, the pressure-equalizing device 11 is mounted directly on the battery housing 2, in particular a protective cover 16 of the pressure-equalizing device 14 is a component of the battery housing 2.

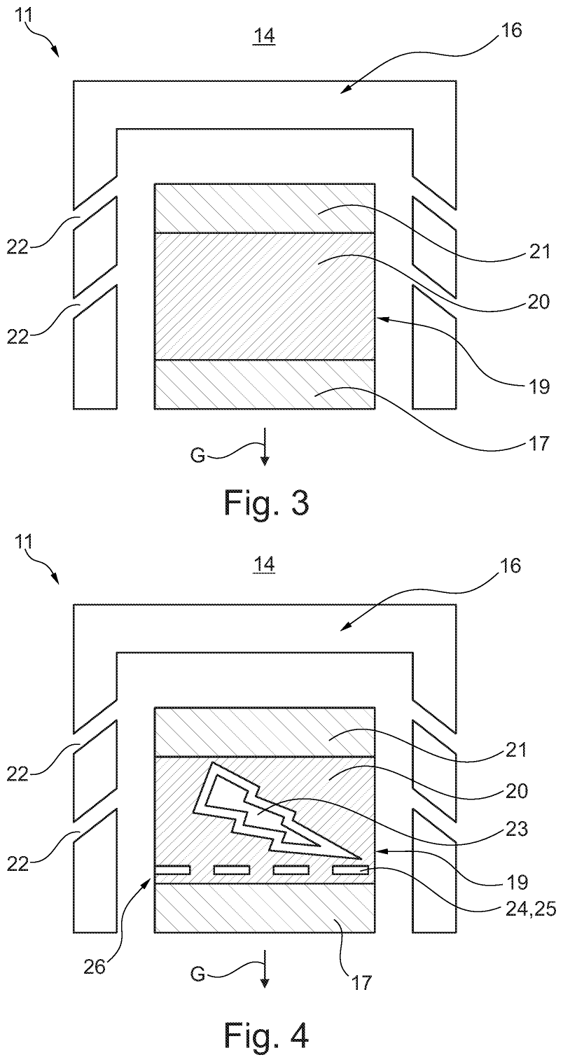

FIGS. 3 and 4 each show an enlarged view of the pressure-equalizing device 14.

The pressure-equalizing device 11 is permeable to gas 12, in particular to air 13, and impermeable to liquid, in particular to cooling liquid 7. For this purpose, the pressure-equalizing device 11 in the examples shown has a first diaphragm 17, which is arranged between the surroundings 14 and the internal volume 18 of the battery housing 2. The first diaphragm 17 is permeable to gas 12, in particular air 13, and impermeable to liquid, in particular water and cooling liquid 7. Therefore, both a flow of cooling liquid 7 from the battery housing 2 into the surroundings 14 and a flow of liquid from the surroundings 14 into the battery housing 7 are prevented or at least reduced.

The pressure-equalizing device 11 also has a drying device 19 which extracts moisture from the gas 12, in particular air 13, flowing through the pressure-equalizing device 11, and collects and/or binds said moisture. For this purpose, the drying device 19 can have a desiccant 20, which may be, for example, silica gel, zeolite and the like or mixtures thereof.

In the examples shown, the pressure-equalizing device 11 has a second diaphragm 21 which is impermeable to liquid, in particular to cooling liquid 7, and permeable to gas 12, in particular air 13. The second diaphragm 21 is arranged between the surroundings 14 and the drying device 19. The drying device 19 is therefore arranged overall between the first diaphragm 17 and the second diaphragm 21.

At least one of the diaphragms 17, 21, preferably the respective diaphragm 17, 21, is also permeable to particles, for example dust and dirt.

The protective cover 16 of the pressure-equalizing device 11 surrounds the diaphragms 17, 21 and the drying device 19. The protective cover 16 has at least one flow opening 22, wherein in each of the examples shown at least two, for example four, flow openings 22 are provided. The respective flow opening 22 connects the pressure-equalizing device 11 fluidically to the surroundings 14 so that a flow is possible between the surroundings 14 and the pressure-equalizing device 11. It is apparent here that the flow openings 22 each run at an incline to the direction G of gravity. In this way, dust and dirt (respectively not shown) are able to enter the pressure-equalizing device 11 only with difficulty. Likewise, it is therefore made at least more difficult for liquid to pass from the surroundings 14 into the pressure-equalizing device 11.

In the exemplary embodiment shown in FIG. 4, the pressure-equalizing device 14 has a heating device 23 which is only illustrated symbolically. The heating device 23 is used to heat the drying device 19, in particular the desiccant 20, for the purpose of regeneration. During the regeneration, moisture which is collected and/or bound in the drying device 20 is discharged from the drying device 19 so that the drying device 19 subsequently extracts moisture again from the gas 12, in particular from the air 13. In order to prevent or at least reduce damage to the first diaphragm 17 and/or to prevent or at least reduce the flow of the released moisture into the battery housing 2 during the regeneration, a closure device 24 is provided which is, for example, a closure flap 25. The closure device 24 is shown in FIG. 4 in a regeneration position 26 in which the closure device 24 shuts a fluidic connection between the drying device 19 and the battery housing 2, in the examples shown between the drying device 19 and the first diaphragm 17. The closure device 24 is adjustable here between the regeneration position 26 and an operating position (not shown) in which the closure device 24 opens the fluidic connection between the drying device 19 and the battery housing 2. In this context, during the regeneration of the drying device 19 the closure device 24 is adjusted into the regeneration position 26, and during the normal operation of the battery system 1 it is adjusted into the operating position (not shown).

The battery system 1 is used, in particular, in a motor vehicle 27. In the motor vehicle 27, the battery system 1 can serve to drive the motor vehicle 27.

1. A battery system, comprising:
a battery housing in which at least one rechargeable battery cell is accommodated;
a pressure-equalizing device through which a gas is flowable to equalize a pressure between the battery housing and a surroundings disposed outside the battery housing;
a circuit through which a cooling liquid circulates during operation;
the battery housing integrated in the circuit such that the cooling liquid flows around the at least one battery cell during operation; and
wherein the pressure-equalizing device is configured such that the pressure-equalizing device is impermeable to the cooling liquid flowing from the circuit in a direction of the surroundings.

2. The battery system according to claim 1, wherein the pressure-equalizing device is mounted on the battery housing.

3. The battery system according to claim 1, wherein the pressure-equalizing device includes a drying device configured to extract moisture from the gas flowing through the pressure-equalizing device.

4. The battery system according to claim 1, wherein the pressure-equalizing device is impermeable to liquid.

5. The battery system according to claim 1, wherein the pressure-equalizing device includes a first diaphragm which is permeable to gas and impermeable to liquid.

6. The battery system according to claim 5, wherein:
the pressure-equalizing device further includes a drying device configured to extract moisture from the gas flowing through the pressure-equalizing device; and
the drying device is arranged between the surroundings and the first diaphragm.

7. The battery system according to claim 6, wherein:
the pressure-equalizing device further includes a second diaphragm which is permeable to gas and impermeable to liquid; and
the second diaphragm is arranged between the drying device and the surroundings.

8. The battery system according to claim 3, wherein the pressure-equalizing device further includes a heating device configured to regenerate the drying device via heating the drying device.

9. The battery system according to claim 8, further comprising a closure device arranged between the drying device and the circuit, wherein the closure device is adjustable between an operating position in which the closure device opens a fluidic connection between the battery housing and the drying device, and a regeneration position in which the closure device shuts the fluidic connection.

10. The battery system according to claim 1, wherein:
the pressure-equalizing device includes a protective cover surrounding the pressure-equalizing device on an outside; and
the protective cover includes at least one flow opening that connects the pressure-equalizing device fluidically to the surroundings.

11. The battery system according to claim 1, further comprising a cooling liquid radiator integrated into the circuit and configured to cool the cooling liquid.

12. The battery system according to claim 3, wherein the drying device is structured and arranged to collect and bind moisture from the gas.

13. The battery system according to claim 12, wherein the drying device includes a desiccant.

14. The battery system according to claim 13, wherein the pressure-equalizing device further includes a heating device configured to regenerate the drying device via heating the desiccant to discharge the moisture from the drying device.

15. The battery system according to claim 13, wherein the desiccant includes at least one of silica gel and zeolite.

16. The battery system according to claim 7, wherein at least one of the first diaphragm and the second diaphragm is permeable to particles.

17. The battery system according to claim 9, wherein the closure device is structured as at least one closure flap.

18. The battery system according to claim 10, wherein the at least one flow opening extends obliquely relative to a direction of gravity.

19. A battery system, comprising:
a battery housing having an internal volume;
a battery module including a plurality of rechargeable battery cells arranged within the battery housing;
a pressure-equalizing mechanism through which a gas is flowable;
a circuit through which a cooling liquid is circulatable;
the internal volume of the battery housing in fluid communication with an external surroundings of the circuit via the pressure-equalizing mechanism;
the battery housing integrated in the circuit such that the cooling liquid is flowable around at least one battery cell of the plurality of battery cells;
wherein the pressure-equalizing mechanism is impermeable to the cooling liquid flowing from the circuit in a direction of the external surroundings; and
wherein a pressure within the battery housing is equalizable with the external surroundings via the pressure-equalizing mechanism.

20. A battery system, comprising:
a battery housing having an internal volume;
a battery module including a plurality of rechargeable battery cells arranged within the battery housing;
a circuit through which a cooling liquid is circulatable;
a pressure-equalizing mechanism through which a gas is flowable, the pressure-equalizing mechanism including:
a dryer configured to extract moisture from the gas flowing through the pressure-equalizing mechanism; and
a heater configured to regenerate the dryer via heating the dryer;
a closure mechanism structured and arranged to selectively close a fluidic connection between the battery housing and the dryer;
the internal volume of the battery housing in fluid communication with an external surroundings of the circuit via the pressure-equalizing mechanism;
the battery housing integrated in the circuit such that the cooling liquid is flowable around at least one battery cell of the plurality of battery cells;
wherein the pressure-equalizing mechanism is impermeable to the cooling liquid flowing from the circuit in a direction of the external surroundings;
wherein a pressure within the battery housing is equalizable with the external surroundings via the pressure-equalizing mechanism; and
wherein, when the heater is heating the dryer, the closure mechanism is disposed in a regeneration position in which the closure mechanism closes the fluidic connection.
